(19) United States
(12) Patent Application Publication
(10) Pub. No.: US 2007/0284878 A1
(43) Pub. Date: Dec. 13, 2007

(54) Sealing fitting for stainless steel tubing

(75) Inventors: Scott Duquette, Enfield, CT (US); Brian R. Kraft, Palmer, MA (US)

Correspondence Address: FOLEY AND LARDNER LLP;SUITE 500, 3000 K STREET NW, WASHINGTON, DC, 20007, US

(73) Assignee: TITEFLEX CORPORATION

(21) Appl. No.: 11/727,283

(22) Filed: Mar. 26, 2007

Related U.S. Application Data
(63) Continuation-in-part of application No. 11/183,189, filed on Jul. 18, 2005.

(51) Int. Cl. F16L 19/00; F16L 33/00

(52) U.S. Cl. 285/245

(57) ABSTRACT

A fitting assembly for forming a fluid-tight seal with an end of a stainless steel tube is provided with an adapter that is composed of a material that is harder than the material that the stainless steel tube is composed of. The adapter may include an insert that is composed of a material that is harder than the material that the stainless steel tube is composed of. The stainless steel tube may be gripped between a bushing that is connected to a nut and an adapter to create the fluid-tight seal. The fitting assembly can be used to form a double-convolution compression in the stainless steel tube.

The present application is a continuation-in-part of U.S. application Ser. No. 11/183,189, filed on Jul. 18, 2005, which is hereby incorporated by reference in its entirety.

### BACKGROUND

The present invention relates to a fitting for sealing an end of a stainless steel tube to create a fluid-tight seal.

In a conventional fitting design for sealing an end of a stainless steel tube, the fitting is sensitive to the quality of the cut end of the stainless steel tube. The stainless steel tube is typically cut in the field and the quality of this cut is difficult to control. Conventional fitting designs implement the surface of the stainless steel tube directly adjoining the cut to form a seal.

However, poor cuts commonly lead to leaks in a piping system with a conventional design. Also, a poor cut that contains burrs, or that is over-tightened in an attempt to eliminate a leak, may damage a fitting.

Conventional fitting designs typically form a seal with a stainless steel tube on the outer diameter of the stainless steel tube. However, the outer diameter of the stainless steel tube is often the site of defects and discontinuities that result from manufacture, shipping, and installation. Deformation or damage on the outer diameter of the stainless steel tube may interfere with a seal to be formed against the outer diameter of the stainless steel tube.

Furthermore, conventional designs are typically sensitive to foreign materials caught inside the adapter body. Such foreign materials may also cause difficulties with forming a fluid-tight seal with a stainless steel tube.

### SUMMARY OF THE INVENTION

An object of the embodiments described herein is to provide an improved fitting for sealing an end of a stainless steel tube to create a fluid-tight seal.

According to an embodiment, an adapter for forming a fluid-tight seal with a stainless steel tube includes an adaptor body and a surface that is adapted to be inserted within an inner diameter of the stainless steel tube and seal the stainless steel tube, wherein the adaptor is composed of a material that is harder than a material that the stainless steel tube is composed of.

According to an embodiment, a fitting assembly for forming a fluid-tight seal with a stainless steel tube includes a nut, a gripping device, and an adaptor that includes a body and a surface that is adapted to be inserted within an inner diameter of the stainless steel tube and seal the stainless steel tube, wherein the adaptor is composed of a material that is harder than a material that the stainless steel tube is composed of.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages will become apparent from the following description, appended claims, and the accompanying exemplary embodiments shown in the drawings, which are briefly described below.

FIG. 1 is an exploded view of a fitting assembly, according to an embodiment.

FIG. 2 is side view of a fitting assembly, according to an embodiment.

FIG. 3 is a sectional view of a fitting assembly taken along line plane C-C in FIG. 2.

FIG. 4 is a detailed view of area A in FIG. 3.

FIG. 5 is a sectional view the present invention.

FIG. 6 is sectional view of a compressor and grooved adapter, according to an embodiment.

FIG. 7 is sectional view of a wide compressor and grooved adapter, according to an embodiment.

FIG. 8 is sectional view of a narrow compressor and grooved adapter, according to an embodiment.

FIG. 9 is sectional view of a compressor and narrowly-grooved adapter, according to an embodiment.

FIG. 10 is sectional view of a compressor and widely-grooved adapter, according to an embodiment.

FIG. 11 is a side view of a one-piece assembly compressor & groove(s) for sealing with a stainless steel tube, according to an embodiment.

FIG. 12 is a side view of an adapter with an internal and external ramp, according to an embodiment.

FIG. 13 is a detailed view of a fitting assembly for a cylindrical stainless steel tube, according to an embodiment.

FIG. 14 is a sectional view of a fitting assembly with an insert according to an embodiment.

FIG. 15 is a detailed view of a fitting assembly for a cylindrical stainless steel tube, according to an embodiment.

FIG. 16 is a sectional view of a fitting assembly with an insert, according to an embodiment.

FIG. 17A is top view of a split ring, according to an embodiment.

FIG. 17B is a sectional view of in the direction indicated by arrow 17B in FIG. 17A.

### DETAILED DESCRIPTION

Representative embodiments will be described below with reference to the drawings. It is understood that the stainless steel tubing be corrugated or straight. The tubing may be shaped in different geometries. In a preferred embodiment, the tube may be cylindrical in shape. The fitting may be used to form fluid-tight seals with stainless steel tubing. Fluids may include gases and liquids.

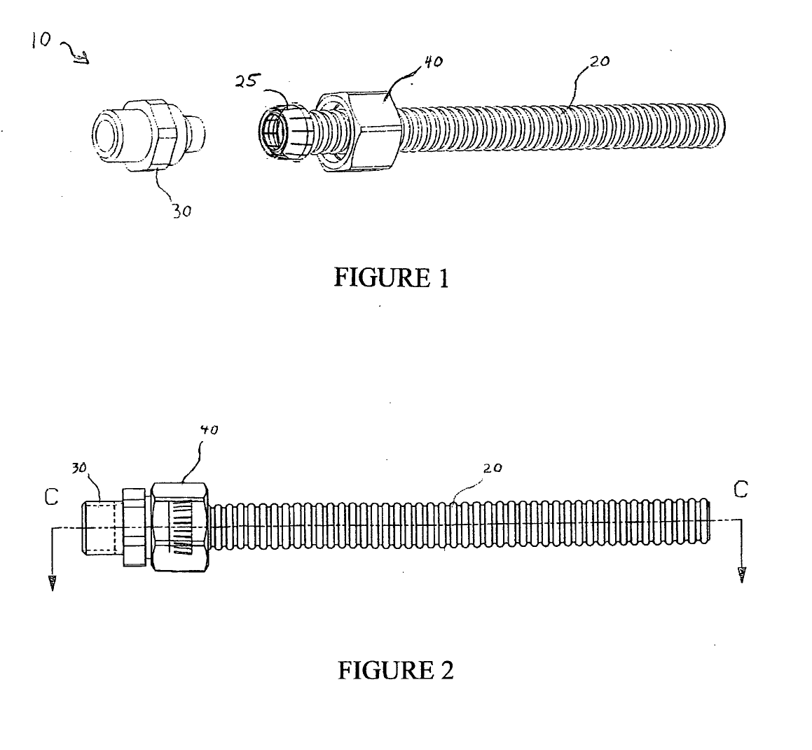

FIG. 1 shows an exploded view of a fitting assembly 10 according to an embodiment. The fitting assembly 10 may be used to seal an end of a stainless steel tube 20 to create a fluid-tight seal. In the example shown in FIG. 1, a corrugated stainless steel tube is shown. The stainless steel tube may have one of its ends cut in preparation to form a seal with the fitting assembly 10. At head of tubing 20 is placed a cap 25. The fitting assembly 10 may include an adapter 30 and a nut 40. The adapter 30 may include a body 32 and a surface 35 of the body 32.

According to an embodiment, the stainless steel tube can be made from a grade of austenitic stainless steel. According to a further embodiment, the stainless steel tube can be made of type 304 stainless steel. According to another embodiment, the stainless steel tube can be made of a material that conforms with ANSI standard LC1, herein incorporated by reference in its entirety.

FIG. 2 shows a side view of the fitting assembly 10 in which the stainless steel tube 20 has been inserted with the adapter 30 and the nut 40 of the fitting assembly 10. In normal operation, the fitting assembly 10 may be assembled by screwing the nut 40 onto the adapter 30, inserting the stainless steel tubing 20 into a gap between the nut 40 and the adapter 30, and tightening the nut 40 onto the adapter 30 to form a fluid-tight seal on the end of the stainless steel tube 20. Assembly may also be performed by disassembling the fitting assy 10, inserting the tube 20 into the nut 40, assembling the bushing 25 to the tubing 20, inserting the assy of nut 40, tubing 20 and bushing 25 into the adapter 30 and tightening the nut 40 to the adapter 30.

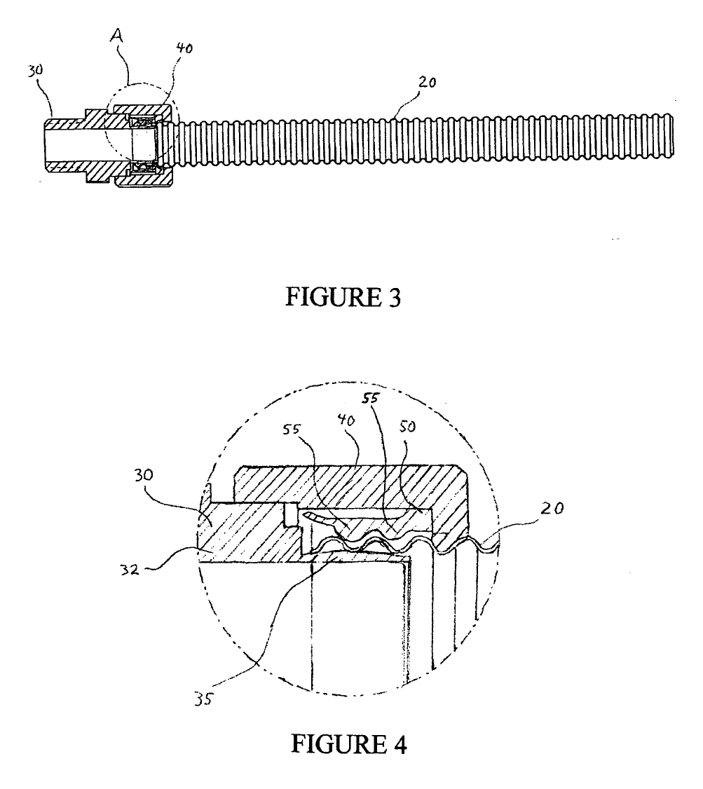

FIG. 3 shows a sectional view of the fitting assembly 10 taken along plane C-C in FIG. 2 according to an embodiment. FIG. 4 shows a detailed view of area A in FIG. 3. The fitting assembly 10 may be assembled by inserting the stainless steel tube 20 in a space that is formed between the nut 40 and the adapter 30, as shown in the example of FIG. 4. For example, the stainless steel tube 20 may be inserted while the nut 40 and the adapter 30 are fastened together, such as when threads of the nut 40 and the adapter 30 are engaged. In this fashion the adapter surface 35 is positioned within the inner diameter of the stainless steel tube 20, effectively centering the stainless steel tube 20 within the adapter 30 and restricting the radial movement of the stainless steel tube 20.

The nut 40 may also include a bushing 50 for compressing the stainless steel tube 20 against a surface 35 of the adapter 30. The adapter surface 35 may be sloped and conical or the surface may be straight. The adapter surface 35 may be smooth or the surface 35 may be grooved or rough. The bushing 50 may be connected to the nut 40. The bushing 50 may include protrusions 55 that press against the stainless steel tube 20. The protrusions 55 may be designed to mate with the corrugations or convolutions of a corrugated stainless steel tube, as shown in the example of FIG. 4.

As the nut 40 is tightened onto the adapter 30, the bushing 50 and the stainless steel tube 20 are forced against the adapter surface 35, causing the bushing 50 to press the stainless steel tube 20 against the adapter surface 35. In this way, the stainless steel tube 20 is gripped and sealed between the bushing 50 and the adapter surface 35 in a fluid-tight manner. Such a fluid-tight seal may be achieved by tightening the nut 40 and bushing 50 until the stainless steel tube 20 is compressed between the bushing 50 and the adapter surface 35 or by tightening the nut 40 and bushing 50 until the stainless steel tube 20 is deformed between the bushing 50 and the adapter surface 35.

For example, the adapter surface 35 may be designed to have a sloped or conical portion, as illustrated in the example of FIG. 4. When the nut 40 is tightened onto the adapter 30, the bushing 50 and the stainless steel tube 20 are initially pressed against the adapter surface 35 so that the stainless steel tube is sealed between the bushing 50 and the adapter surface 35. However, as the nut 40 is tightened further, the bushing 50 and stainless steel tube 20 are forced further up the slope of the adapter surface 35, causing the stainless steel tube 20 to deform. In this manner, the inner diameter of the stainless steel tube 20 may be stretched over the conical area of the adapter surface 35. Further tightening of the nut 40 beyond this point causes the outer diameter of the stainless steel tube 20 to further contact and conform to the bushing 50. At this point there is complete contact between the adapter surface 35, the stainless steel tube 20, and the bushing 50, creating a fluid-tight seal.

By sealing the stainless steel tube 20 between the bushing 50 and the adapter surface 35, instead of simply gripping the stainless steel tube 20 on the outer diameter of the stainless steel tube 20, the sensitivity of the fitting assembly 10 to defects and damage on the outer surface of the stainless steel tube 20 is greatly reduced.

By tightening the fitting assembly 10 until the stainless steel tube is deformed between the adapter surface 35 and the bushing 50, the sensitivity of the fitting assembly 10 to defects or damage on the outer surface of the stainless steel tube 20 is greatly reduced.

The adapter surface 35 may be sloped to different angles. For example, the adapter surface 35 may have a slope of 0-30 degrees. In a further example, the adapter surface may have a slope of 0, 5, 10, 15, 20, or 25 degrees.

The stainless steel tube 20 may be gripped or compressed at a point that is one or more convolutions from the cut end of the stainless steel tube 20. In the example of FIG. 4 the stainless steel tube 20 is gripped at one convolution from the cut end of the stainless steel tube 20. However, the stainless steel tube may instead be gripped at a point that is two or three or more convolutions from the cut end of the stainless steel tube 20.

Other gripping devices may be used instead of the nut 40 and the bushing 50 shown in the example of FIG. 4. For example, a nut-integrated collet, a colleted nut, a slip or other types of rings, and other gripping devices known in the fitting arts may be used.

According to an embodiment, the adapter 30 is composed of a material that is harder than the material that the stainless steel tube is composed of. Conventional adapters are typically manufactured as one machined part of a material that is softer than the stainless steel tube 20. For example, conventional adapters are typically composed of a brass alloy. Using a harder material for the adapter 30 minimizes the damage to an adapter 30 due to a poorly cut stainless steel tube 20 end. For example, the use of a harder material for the adapter 30 can minimize scoring of the adapter 30, or insert 60 as will be discussed below, by the stainless steel tube, which would lead to poor performance of the fitting assembly 10. Therefore, the sealing end of the adapter 30 will not be damaged and a fluid-tight seal may be formed with the stainless steel tube 20. Additionally, foreign material is less likely to damage the adapter 30 and interfere with the formation of a fluid-tight seal.

For example, the stainless steel tube is made of a material with a hardness of approximately 200-300 Hv, or a hardness of approximately 11-30 on the HRC scale. Therefore, a component of a fitting assembly 10 or portion of such a component, such as an adapter 30 or insert 60, can be made of a material that is harder than the material that the stainless steel tube is made of. For example, a component, or portion of the component, can be made of a material with a hardness greater than or equal to approximately 30 HRC. In another example, the component, or portion of the component, can be made of a material with a hardness of greater than or equal to approximately 35 HRC. In a further example, the component, or portion of the component, can be made of a material with a hardness of greater than or equal to approximately 40 HRC. In a further example, the component, or portion of the component, can be made of a material with a hardness of greater than or equal to approximately 45 HRC. In a further example, the component, or portion of the component, can be made of a material with a hardness of greater than or equal to approximately 50 HRC.

The adapter 30 may be composed of metal that is harder than material that the stainless steel tube 20 is composed of. For example, the adapter 30 may be composed of tool steels, stainless steels, alloy steels, and other alloys that are harder than the material that the stainless steel tube 20 is composed of. In a further example, the adapter 30 may be composed of martensitic stainless steel, or a tool steel. In a preferred embodiment, the adapter 30 is composed of a martensitic stainless steel or tool steel that is in a hardened condition. For example, the adapter 30 can be made of a martensitic stainless steel, such as type 410, type 420, or type 431 stainless steel in a hardened or tempered condition. In further example, the adapter 30 can be made of A2 tool steel in a hardened or aged condition. In a further embodiment, the adapter 30 can be coated with a corrosion-resistant coating. For example, the adapter 30 can be coated with a corrosion-resistant coating when the adapter 30 is made of a tool steel, alloy steel, or other alloy that is susceptible to corrosion.

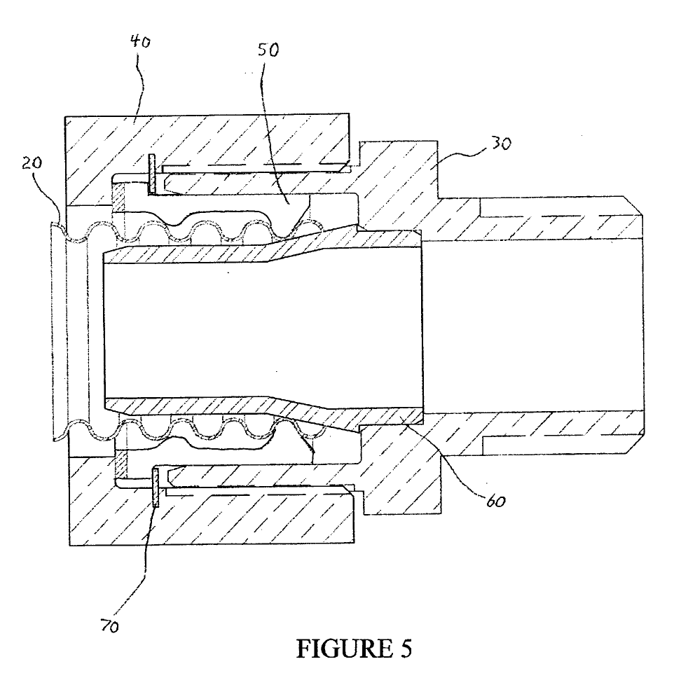

FIG. 5 shows an embodiment in which the adapter 30 includes an insert 60. In the example shown in FIG. 5, the adapter 30 may be composed of a relatively soft material while the insert 60 may be composed of a material that is harder than the material that the stainless steel tube 20 is composed of. In this embodiment the advantages of using a hard material (such as reducing the sensitivity of the adapter 30 to badly cut stainless steel tube 20 ends and foreign materials) are realized while the material costs of the adapter 30 may be reduced. Materials harder than that of the stainless steel tube 20 may be more expensive than conventional materials used for the adapter. By limiting the hard material to the insert 60, the material costs of the adapter may be minimized.

The insert 60 may be joined to the adapter 30 by press fitting, fastening, brazing, welding, or other joining processes known in the art.

In the example of FIG. 5 a ring 70 is used to join the bushing 50 to the nut 40. In this manner, the bushing 50 is connected to the nut 40 so that the bushing 50 may move in a radial direction, aiding with the insertion of the stainless steel tube 20 into the fitting assembly 10 and the sealing of the stainless steel tube. The bushing 50 may be connected to the nut 40 with other devices such as washers and other connecting devices known in the art, or the bushing 50 may be captured by the nut 40 by swaging, crimping, or other devices known in the art.

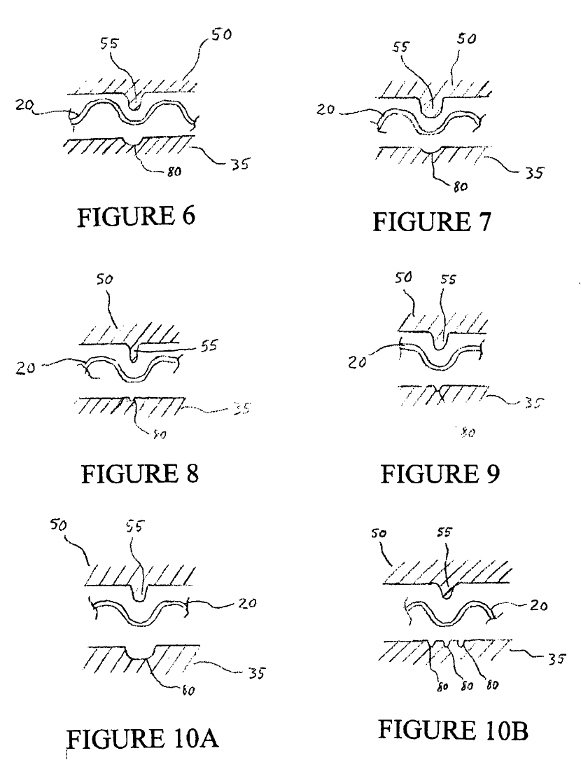

FIG. 6 shows an embodiment in which a protrusion 55 of the bushing 50 is used to grip the stainless steel tube 20 with a groove 80. In all cases where a groove is shown, it is understood that a multitude or series of grooves may also be employed. In the example shown in FIG. 6, the groove 80 is formed in the adapter surface 35. However, the groove 80 may instead be formed on the surface of the insert 60. When the nut 40 is tightened onto the adapter 30, the bushing 50 and protrusion 55 press the stainless steel tube 20 against the adapter surface 35 so that the protrusion 55 presses the stainless steel tube 20 against the groove 80 to grip the stainless steel tube 20 and form a fluid-tight seal. The nut 40 may be further tightened on the adapter 30 to cause the bushing 50, the protrusion 55, the groove 80, and the adapter surface 35 to further grip the stainless steel tube 20 and cause the stainless steel tube 20 to deform.

FIG. 7 shows an embodiment in which a wide protrusion 55 and a wide groove 80 are used so that the stainless steel tube is sealed over a wider area. For example, a wide protrusion 55 and a wide groove 80 may be used to increase the gripping area to further insure that a fluid-tight seal is formed between the bushing 50 and the adapter 30. A single groove or multiple grooves may be provided in this fashion.

FIG. 8 shows an embodiment in which a narrow protrusion 55 and a narrow groove 80 are used so that the stainless steel tube is sealed over a more narrow area. For example, a narrow protrusion 55 and a narrow groove 80 may be used to concentrate the gripping force between the bushing 50 and the adapter 30 and increase the deformation of the stainless steel tube 20 in a desired area. A single groove or multiple grooves may be provided in this fashion.

FIG. 9 shows an embodiment in which a protrusion 55 is wider than a groove 80. For example, a protrusion 55 that is relatively wider than the groove 80 may be used to enhance deformation and sealing with the stainless steel tube 20.

FIG. 10 shows an embodiment in which a groove 80 is wider than a protrusion 55. For example, a wider groove 80 may be used to cause the protrusion 55 and the stainless steel tube 20 to fit within the groove 80 and enhance sealing with the stainless steel tube 20. A single groove or multiple grooves may be provided in this fashion.

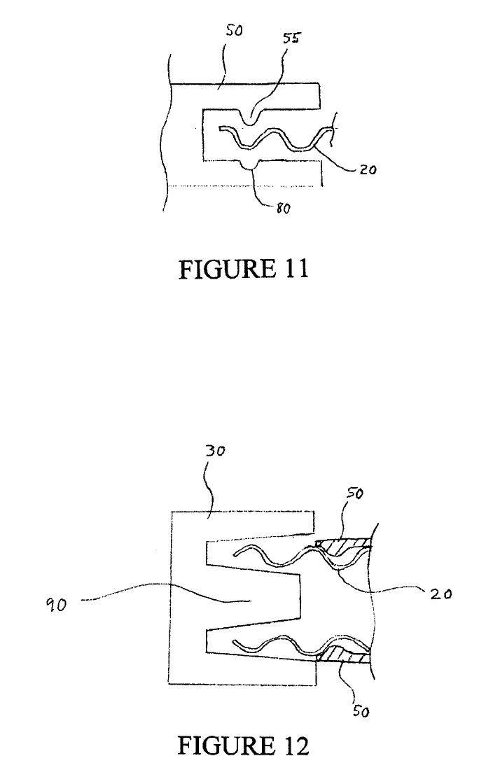

FIG. 11 shows an embodiment in which a one-piece protrusion/groove assembly 50 includes a protrusion 55 and a groove 80 on a surface of the protrusion/groove assembly 50 for sealing a stainless steel tube 20. For example, a one-piece protrusion/groove assembly 50 may be used to minimize displacement of the stainless steel tube 20 in an undesired direction when the stainless steel tube 20 is inserted into the fitting assembly 10 and gripped by the one-piece protrusion/groove assembly 50. In this embodiment, tightening the nut 40 causes the protrusion/groove assembly 50 to compress, thus causing a fluid-tight seal between the protrusion 55, tube 20 and groove 80. The protrusion/groove assembly 50 may include a single groove or multiple grooves.

FIG. 12 shows an embodiment in which an adapter 30 includes an internal ramp 90 for sealing the inner diameter of the stainless steel tube 20. For example, a nut 40 may thread to the exterior of the adapter 30 while the bushing 50 is fit inside the adapter 30 so that the bushing 50 presses the stainless steel tube to the internal ramp 90 as the nut 40 is tightened onto the adapter 30.

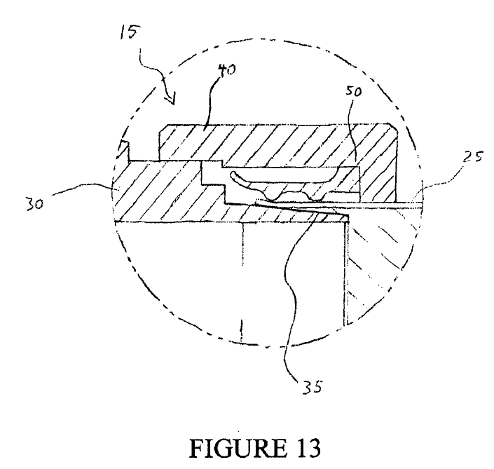

FIG. 13 shows a detailed view of an embodiment in which a straight or flat stainless steel tube 25 forms a fluid-tight seal with a fitting assembly 15. In the example shown in FIG. 13, a nut 40 is tightened on an adapter 30 to seal the stainless steel tube 25 between a bushing 50 and the adapter surface 35. The adapter surface 35 is sloped or conical so that as the nut 40 is tightened the bushing 50 and the adapter surface 35 seal the stainless steel tube 25. The nut 40 may be further tightened on the adapter 30 so that the stainless steel tube 25 is deformed between the bushing 50 and the adapter surface 35.

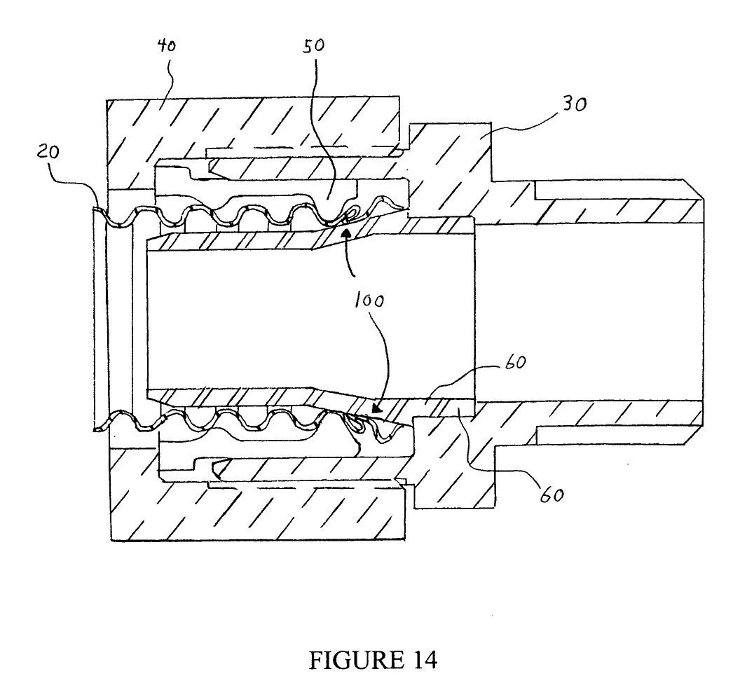

FIG. 14 shows a sectional view of an embodiment of a fitting assembly. The fitting assembly includes an adapter 30 with an insert 60, a nut 40, and a bushing 50. The adapter 30, nut 40, and bushing 50 can be constructed according to any of the embodiments described above. For example, the adapter 30 can be made with a one-piece construction as described above, can include a ring 70 to join the bushing 50 to the nut 40, or include any features of the embodiments described above.

According to an embodiment, the fitting assembly can be used to form a fluid-tight seal with a stainless steel tube 20 by deforming the stainless steel tube 20 to form a double-convolution compression 100 in the stainless steel tube 20. Such a double-convolution compression 100 can be formed by inserting the stainless steel tubing 20 into a gap between the nut 40 and the adapter 30 and tightening the nut 40 onto the adapter 30. As the nut 40 is tightened onto the adapter 30, the bushing 50 and the stainless steel tube 20 are forced against a surface of the insert 60, causing the bushing 50 to press the stainless steel tube 20 against the insert 60. As the nut 40 is tightened and the bushing 50 is pressed against the stainless steel tube 20, sufficient force can be generated to deform the stainless steel tube 20 and cause the stainless steel tube 20 to fold upon itself to form a double-convolution compression 100, as shown in FIG. 14. Such a double-convolution compression 100 of the stainless steel tube 20 can aid in the formation of a fluid-tight seal between the stainless steel tube 20 and the fitting assembly. By sealing the stainless steel tube 20 between the bushing 50 and the adapter surface 35, instead of simply gripping the stainless steel tube 20 on the outer diameter of the stainless steel tube 20, the sensitivity of the fitting assembly 10 to defects and damage on the outer surface of the stainless steel tube 20 is greatly reduced and an improved fluid-tight seal can be formed.

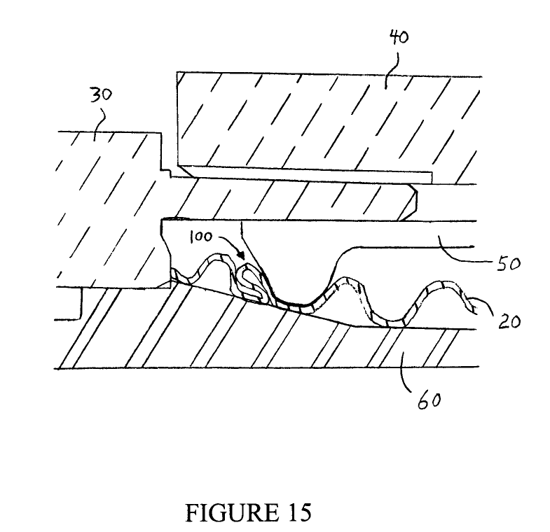

FIG. 15 shows a detailed view of a double-convolution compression 100 of a stainless steel tube 20 that is formed by the fitting assembly. As shown by FIG. 15, the stainless steel tube 20 can be deformed so that at least one convolution of the stainless steel tube 20 is folded and/or flattened against the stainless steel tube 20 to form a double-convolution compression 100. For example, a convolution or ridge of the stainless steel tube 20 can be deformed and folded into a trough of the stainless steel tube 20 to form a double-convolution compression 100. Such a double-convolution compression 100 can be forcibly held between the bushing 50 and the insert 60 of the adapter 30 to form a fluid-tight seal with the stainless steel tube 20.

As indicated in FIGS. 14 and 15, the double-convolution compression 100 can be formed at a distance away from an end of a stainless steel tube 20. According to another embodiment, a double-convolution compression 100 can be formed at an end of the stainless steel tube 20.

According to another embodiment, other devices may be used instead of bushing 50, such as, for example, a ring, a split ring, a washer, a collet, or other devices known in the art.

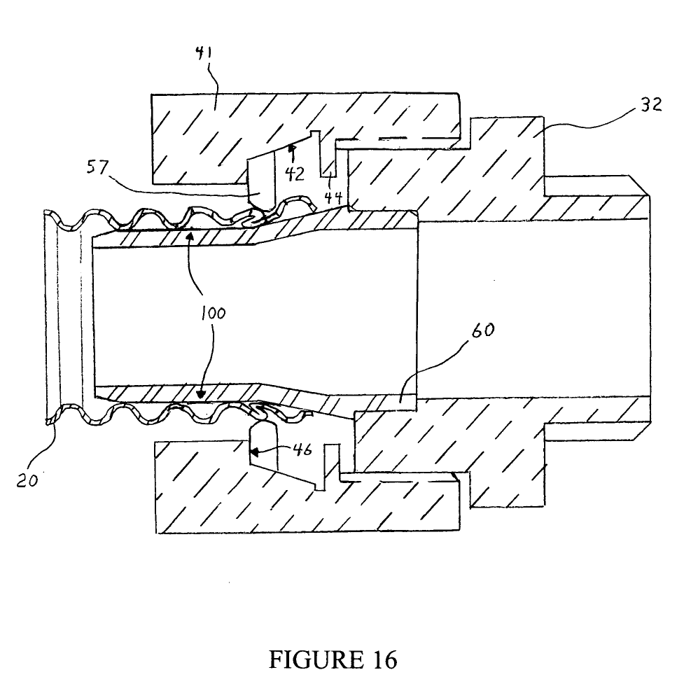

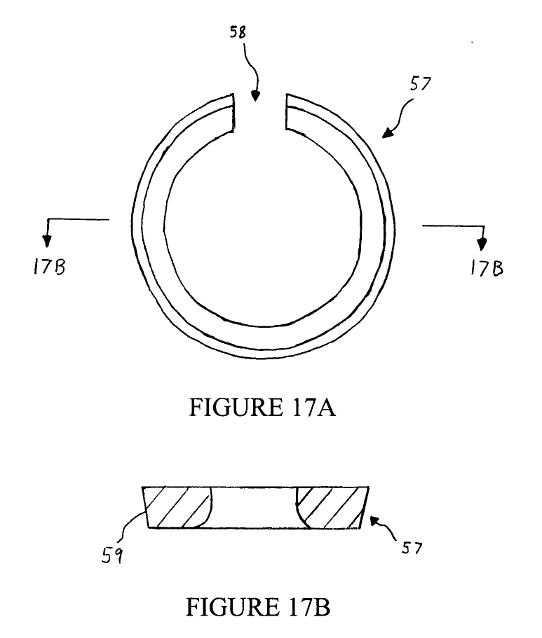

FIG. 16 shows a sectional view of a further embodiment of a fitting assembly for making a fluid-tight seal with a stainless steel tube 20. In contrast to the embodiment shown in FIGS. 14 and 15, the embodiment of FIG. 16 includes a split ring 57 instead of a bushing. FIG. 17A shows a top view of an embodiment of a split ring 57 and FIG. 17B shows a sectional view of the split ring 57 in the direction indicated by arrow 17B in FIG. 17A. A split ring 57 can be made of a resilient material that permits the split ring to flex and deform in an elastic manner. As shown in the example of FIG. 17A, a split ring 57 includes a gap 58 that permits the diameter of the split ring 57 to expand or contract when force is applied to the split ring 57 during tightening of a fitting assembly.

As shown in the example of FIG. 17B, a split ring 57 can be configured so than an inner circumferential surface of the split ring 57 engages a stainless steel tube 20 and an outer circumferential surface 59 is configured to engage a sloped surface 42 of a nut 41. The outer circumferential surface 59 can be angled to conform to a sloped surface 42 of a nut 41. The example of FIG. 17B shows that an inside circumferential surface of a split ring 57 can have a rounded contour to conform to a corrugation or trough of a stainless steel tube 20. However, a split ring 57 can have other shapes for an inside circumferential surface, such as a flat or substantially flat surface or a surface without a suitable chamfer or radius.

The fitting assembly shown in FIG. 16 includes a nut 41 that is configured for use with a split ring 57. A nut 41 can include a sloped surface 42 that is configured to force the split ring 57 against a stainless steel tube 20 as the nut 41 is tightened onto on an adapter 32 that is configured for use with nut 41. The adapter 32 can be configured according to an of the embodiments described above. For example, the adapter 32 can include an insert 60 or have a one-piece construction. The nut 41 can further include a flange 44 and a shoulder 46 to retain a split ring within the nut 41 along the inside sloped surface 42.

As shown in the example of FIG. 16, a fitting assembly with a split ring 57 can be used to deform and/or fold a stainless steel tube 20 to form a double-convolution compression 100 in the stainless steel tube 20. The details of a double-convolution compression 100 of FIG. 16 can be similar to those shown in the example of FIG. 15.

A double-convolution compression 100 can be formed with the fitting assembly of FIG. 16 by inserting the stainless steel tube 20 into a gap between a nut 41 and an adapter 32, and tightening the nut 41 onto the adapter 32. As the nut 41 is tightened onto the adapter 32, force is exerted on the split ring 57 to cause the split ring 57 to flex and mate with the stainless steel tube 20. The sloped surface 42 of nut 41 presses against the outer circumferential surface 59 of the split ring 57, thus forcing the split ring 57 against a stainless steel tube 20, as the nut 41 is tightened onto an adapter 32.

For example, when the nut 41 is tightened onto the adapter 32, a corrugation or ridge of the stainless steel tube 20 can abut against the inner circumferential surface of the split ring 57, causing the split ring 57 to flex and expand outwards. As the nut 41 is further tightened, the split ring 57 can be forced into a trough of the stainless steel tube 20, permitting the split ring 57 to contract in diameter. Continued tightening of the nut 41 can cause the split ring 57 to abut against an adjacent corrugation or ridge of the stainless steel tube 20, thus causing the corrugation or ridge to deform or fold to create a double-convolution compression 100 as the stainless steel tube 20 is compressed between the split ring 57 and an inclined surface of the insert 60 of the adapter 32.

By sealing the stainless steel tube 20 between the bushing 50 and the adapter surface 35, instead of simply gripping the stainless steel tube 20 on the outer diameter of the stainless steel tube 20, the sensitivity of the fitting assembly 10 to defects and damage on the outer surface of the stainless steel tube 20 is greatly reduced and an improved fluid-tight seal can be formed.

Given the present disclosure, one versed in the art would appreciate that there may be other embodiments and modifications within the scope and spirit of the invention. Accordingly, all modifications attainable by one versed in the art from the present disclosure within the scope and spirit of the present invention are to be included as further embodiments.

What is claimed is:

1. An adapter for forming a fluid-tight seal with a stainless steel tube, comprising:
a body; and
a surface of the body that is adapted to be inserted within an inner diameter of the stainless steel tube and to seal with the stainless steel tube;
wherein the adapter is configured to form a double-convolution compression in the stainless steel tube.

2. The adapter of claim 1, wherein the adapter is configured to form the double-convolution compression at a position distal from an end of the stainless steel tube.

3. A fitting assembly for forming a fluid-tight seal with a stainless steel tube, comprising:
an adapter that includes a body and a surface of the body that is adapted to be inserted within an inner diameter of the stainless steel tube and to seal with the stainless steel tube; and
a gripping device;
wherein the fitting assembly is configured to form a double-convolution compression in the stainless steel tube.

4. The fitting assembly of claim 3, wherein the gripping device is a bushing.

5. The fitting assembly of claim 3, wherein the gripping device is a ring.

6. The fitting assembly of claim 3, wherein the gripping device is a collet.

7. The fitting assembly of claim 3, wherein the adapter is configured to form the double-convolution compression at a position distal from an end of the stainless steel tube.

8. The fitting assembly of claim 3, wherein the fitting assembly is configured to press the stainless steel tube between the gripping device and the adapter.
